(19) United States
(12) Patent Application Publication
(10) Pub. No.: US 2012/0222317 A1
(43) Pub. Date: Sep. 6, 2012

(54) CUTTER BLADE HEAD FOR FIBER ROVING CHOPPER

(75) Inventors: James H. Rohrer, Randolph, NJ (US); Jonathan R. McMichael, North Canton, OH (US)

(73) Assignee: GRACO MINNESOTA INC., Minneapolis, MN (US)

(21) Appl. No.: 13/501,211

(22) PCT Filed: Nov. 23, 2010
(86) PCT No.: PCT/US10/03029

§ 371 Date: Apr. 10, 2012

Related U.S. Application Data
(60) Provisional application No. 61/263,503, filed on Nov. 23, 2009.

(51) Int. Cl. A01D 34/42

(52) U.S. Cl. 30/300

(57) ABSTRACT

A blade cartridge for a fiber roving chopper comprises an annular support and a plurality of blade holders. Each of the plurality of blade holders comprises a main body portion, a first end, a second end, and a blade. The first end of the main body portion is connected to the annular support. The second end of the main body portion is opposite the first end such that the main body portion is cantilevered from the annular support. The blade is integrally seated in the main body portion and extends between the first end and the second end. In a further embodiment of the invention, the main body portion of the blade holder includes first and second end notches that extend through the main body portion and the blade.

### CROSS-REFERENCE TO RELATED APPLICATION(S)

This application claims priority under 35 U.S.C. §120 to U.S. provisional application Ser. No. 61/263,503, entitled “CUTTER EDGE,” filed Nov. 23, 2009 by inventors James Rohrer and Jonathan McMichael, the contents of which are incorporated by this reference.

This application claims priority under 35 U.S.C. §119 to PCT application Serial No. PCT/2010/______, entitled “CUTTER BLADE HEAD FOR FIBER ROVING CHOPPER,” filed Nov. 23, 2010 by inventors James Rohrer and Jonathan McMichael, the contents of which are incorporated by this reference.

The present application is related to the following co-pending application filed on the same day as this application, entitled “ANVIL FOR FIBER ROVING CHOPPER” by inventor James Rohrer and having U.S. patent application Ser. No. ______ Attorney Docket Number G372.12-021, the contents of which are incorporated by this reference.

### BACKGROUND

The present invention relates generally to a chopper device that distributes fiber material into a stream of resin material dispensed from a spray gun. In particular, the present invention relates to a blade assembly used in the chopper device.

Chopper guns are frequently used in the composite material industry to form large, shaped products, such as in the marine and watercraft industries and pool and spa industries. Chopper guns comprise assemblies of a fiber chopper and a liquid spray gun. Compressed air is typically supplied to the chopper gun to power a pumping mechanism in the spray gun and an air motor in the fiber chopper. The spray gun typically receives a liquid resin material and a liquid catalyst material. Actuation of a trigger on the gun dispenses the materials into a mix chamber before being sprayed out of a nozzle of the gun. Mixing of the catalyst with the resin begins a solidification process, which eventually leads to a hard, rigid material being formed upon complete curing of the materials. The fiber chopper is typically mounted on top of the spray gun. The fiber chopper receives rovings of a fiber material, such as fiberglass, which passes between an idler wheel, an anvil and a cutter blade head. The fiber rovings are cut into small segments between the anvil and cutter blade head while being propelled out of the chopper by rotation of the anvil and the cutter blade head by the air motor. The segments of fiber are mixed into the sprayed mixture of resin and catalyst such that the final cured product is fiber reinforced.

The blade head and anvil of the fiber chopper include consumable pieces that must be replaced after a threshold wear level is surpassed. For example, the blade head typically includes a plurality of razor blades inserted into slots on a blade wheel. Also, the anvil includes a roller of soft material into which blades of the cutter blade head penetrate while slicing or chopping the fiber roving. Thus, it is necessary to frequently disassemble the fiber chopper to access the cutter blade head and anvil, after which further disassembly of those components is also needed. In particular, it is necessary to remove the anvil roller and each blade of the cutter blade head. Prior art blade heads have involved using a blade bar and a wave spring that retains each razor blade within a slot of the blade wheel. Other prior art methods have involved using wedges that clamp the razor blades in place using set screws. These techniques are tedious and labor intensive and provide higher risk to operators because handling of each blade is required when removing old blades and inserting new blades into the blade wheel. There is, therefore, a need for a simpler system and method for retaining razor blades in a cutter blade head for a fiber roving chopper.

### SUMMARY

The present invention is directed to a blade cartridge for use in a fiber roving chopper. The blade cartridge comprises an annular support and a plurality of blade holders. Each of the plurality of blade holders comprises a main body portion, a first end, a second end, and a blade. The first end of the main body portion is connected to the annular support. The second end of the main body portion is opposite the first end such that the main body portion is cantilevered from the annular support. The blade is seated in the main body portion and extends between the first end and the second end. In a further embodiment of the invention, the main body portion of the blade holder includes first and second end notches that extend through the main body portion and the blade.

### BRIEF DESCRIPTION OF THE DRAWINGS

FIG. 1 is an exploded view of a liquid spray gun and a fiber roving chopper assembly in which a cutter blade head of the present invention is used.

FIG. 2A is a perspective view of the fiber roving chopper of FIG. 1 showing a cutter blade head.

FIG. 2B is a rear end view of the fiber roving chopper of FIG. 1 showing fiber roving inlet holes.

FIG. 2C is a perspective view of the fiber roving chopper of FIG. 1 with a cover removed to show a cutter blade head, an anvil and an idler wheel.

FIG. 3A is a perspective view of the cutter blade head of FIG. 2C.

FIG. 3B is a front view of the cutter blade head of FIG. 3A.

FIG. 3C is a first side view of the cutter blade head of FIG. 3B.

FIG. 3D is a second side view of the cutter blade head of FIG. 3B.

FIG. 3E is a front view of the cutter blade head of FIG. 3C.

FIG. 3F is an exploded view of the cutter blade head of FIG. 3A showing a retention cap, a blade cartridge, a spacer spool and an end cap.

FIG. 4A is a perspective view of the blade cartridge of FIG. 3F showing a wall segment connecting concentric rings that support a plurality of blade holders.

FIG. 4B is a cross-sectional view of a wall segment of FIG. 4A taken at section 4B-4B.

FIG. 4C is a cross-sectional view of a blade holder of FIG. 4A taken at section 4C-4C.

FIG. 5 is an exploded view of the retention cap of FIG. 3F showing a retention tab and a biasing spring.

### DETAILED DESCRIPTION

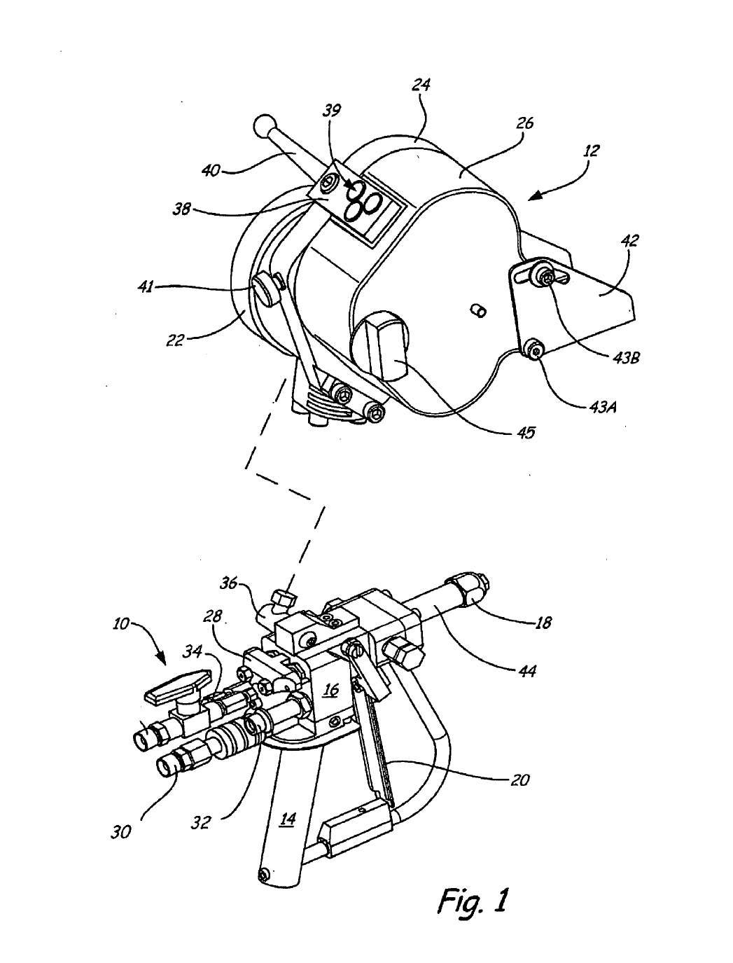

FIG. 1 is an exploded view of an assembly of liquid spray gun 10 and fiber roving chopper 12 in which a cutter blade head of the present invention is used. In FIG. 1, fiber roving chopper 12 is shown slightly enlarged with respect to liquid spray gun 10. Liquid spray gun 10 comprises a two component internal mixing gun having handle 14, valve body 16, nozzle 18 and trigger 20. Fiber roving chopper 12 includes air motor 22, housing 24 and cover 26. Valve body 16 of spray gun 10 includes valve assembly 28, air inlet 30, material inlet 32, catalyst inlet 34 and air outlet 36. Housing 24 of fiber roving chopper 12 includes fiber inlet 38, openings 39, lever 40, knob 41, fasteners 43A and 43B, knob 45, and cover 26 includes dispenser chute 42.

In the embodiment shown, spray gun 10 comprises a two component mixing gun that receives two liquid components that mix when dispensed to produce a mixture that cures into a hardened material. A first component comprises a resin material, such as a polyester resin or a vinyl ester, and is fed into valve body 16 at material inlet 32. A second component comprises a catalyst material that causes the resin material to harden, such as Methyl Ethyl Ketone Peroxide (MEKP), and is fed into valve body 16 at catalyst inlet 34. Material inlet 32 and catalyst inlet 34 feed materials, respectively, into valves seated within valve body 16 and connected to valve assembly 28. Other inlets are provided to gun 10 for other fluids such as a solvent. Actuation of trigger 20 simultaneously causes valves of valve assembly 28 to open and causes pressurized components to flow into nozzle 18. As shown, spray gun 10 comprises an internal mixer where the two components are pressurized at inlets 32 and 34 by an external source (not shown) and mixed within tube 44 before entering nozzle 18. Pressurized air may also be provided to nozzle 18 to shape or direct the mixed flow stream. In other embodiments, the materials are mixed outside of gun 10 after being pressurized within valve body 16 with air from inlet 30 and atomized by a mixing nozzle.

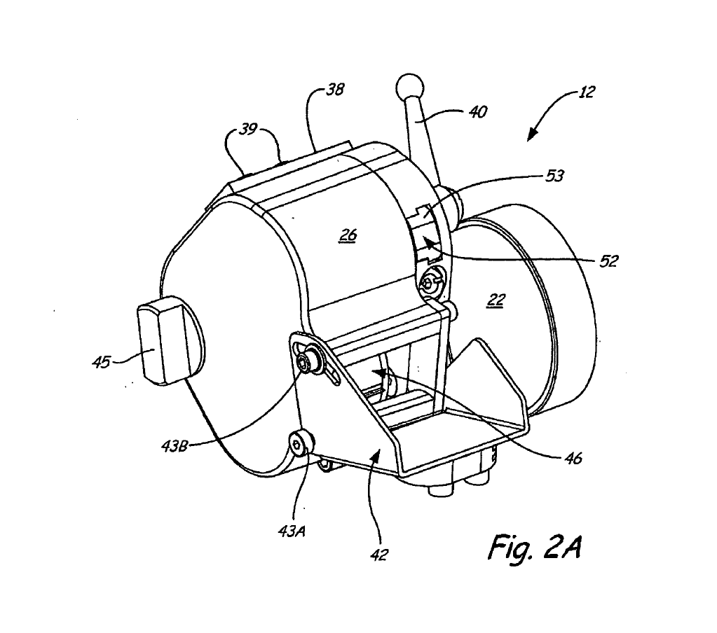

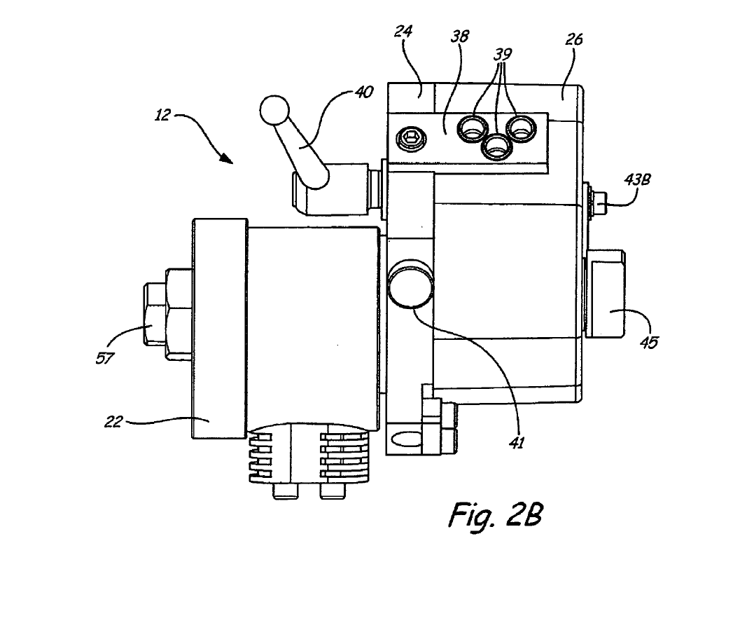

Pressurized air from air inlet 30 is also fed through valve body 16 to outlet 36, which connects to an inlet (not shown) on air motor 22 of fiber chopper 12. Rovings or strands of a fiber material, such as fiberglass, are fed into cover 26 through openings 39 in fiber inlet 38. Activation of air motor 22 by actuation of trigger 20 causes the rovings to be pulled into a cutter blade head by an anvil and idler wheel mounted on housing 24, as will be discussed in greater detail with respect to FIG. 2C. Positions of the anvil and idler wheel are adjusted with respect to the cutter blade head using lever 40 and knob 41. The chopped roving pieces are expelled from dispenser chute 42 into the mixed stream of resin and catalyst materials from nozzle 18 such that the hardened material includes fiber reinforcements that increase strength of the final product.

It is frequently necessary to remove cover 26 from housing 24 of chopper 12 to perform routine maintenance after spray gun 10 and fiber chopper 12 are operated. Specifically, blades of the cutter blade head and a cutting surface of the anvil must be replaced, as the blades become dull from cutting the rovings and the cutting surface becomes lacerated from the blades. The cutter blade head of the present invention is quickly and easily removed from chopper 12 once cover 26 is removed. Furthermore, blades can be easily and safely replaced in the cutter blade head of the present invention.

FIG. 2A is a perspective view of fiber roving chopper 12 of FIG. 1 showing cutter blade head 46. FIG. 2B is a top view of fiber roving chopper 12 of FIG. 1 showing fiber roving inlet holes 39. FIG. 2C is a perspective view of fiber roving chopper 12 of FIG. 1 with cover 26 removed to show cutter blade head 46, anvil 48 and idler wheel 50. FIGS. 2A-2C are discussed concurrently, with specific emphasis on FIG. 2C. Fiber chopper 12 also includes air motor 22, housing 24, fiber inlet 38, openings 39, lever 40, knob 41, dispenser chute 42, fasteners 43A and 43B, knob 45, slide bar assembly 52 and tube 55. Cutter blade head 46 includes blades 54, blade cartridge 56, spacer spool 58 and retention cap 60. Anvil 48 includes roller 62, retention cap 64 and fastener 66. Idler wheel 50 includes roller 68 and fastener 70.

Cover 26 comprises a multi-sided body having an opening that mates with housing 24 to conceal cutter blade head 46, anvil 48 and idler wheel 50. Cover 26 includes an opening to allow chopped rovings from cutter blade head 46 to be thrown from chopper 12. Dispenser chute 42 mounts to cover 26 with fasteners 43A and 43B near the opening to receive chopped rovings from cutter blade head 46. Dispenser chute 42 comprises a three-sided angled plate along which chopped rovings pass after being cut by chopper head assembly 46. The angle of dispenser chute 42 on fasteners 43A can be adjusted using fasteners 43B to change the trajectory of the chopped roving pieces. Knob 45 extends into cover 26 to engage tube 55 (FIG. 2C) and retain cover 26 in engagement with housing 24.

With reference to FIG. 2C, cutter blade head 46, anvil 48 and idler wheel 50 are mounted for rotation on housing 24. Specifically, cutter blade head 46 is mounted directly onto a drive shaft extending from shaft support 57 (FIG. 2B) of air motor 22, through housing 24, and into retention cap 60. Anvil 48 and idler wheel 50 are mounted to shafts cantilevered from slide bar assembly 52 in housing 24. Fasteners 66 and 70 are typically in threaded engagement with the shafts to retain anvil 48 and idler wheel 50, respectively. Slide bar assembly 52 comprises a rectangular bar that extends into a corresponding slot in housing 24 between knob 41 and end stop 53. A spring biases the slide bar away from end stop 53, which is secured to housing 24, to push anvil 48 into contact with cutter blade head 46. Lever 40 is used to adjust the position of the slide bar, including anvil 48 and idler wheel 50, with respect to cutter blade head 46 by overcoming the spring bias. The position of idler wheel 50 with respect to anvil 48 on the slide bar of slide bar assembly 52 is adjusted using knob 41. Adjustment of knob 41 allows for rovings of different thicknesses to be fed between anvil 48 and idler wheel 50. Adjustment of lever 40 controls engagement of cutter blade head 46 with anvil 48, thereby controlling feeding of rovings into fiber inlet 38.

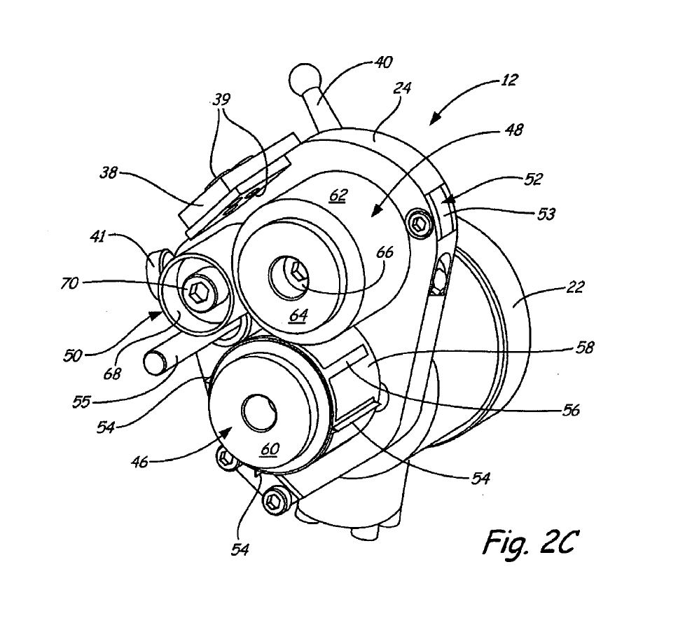

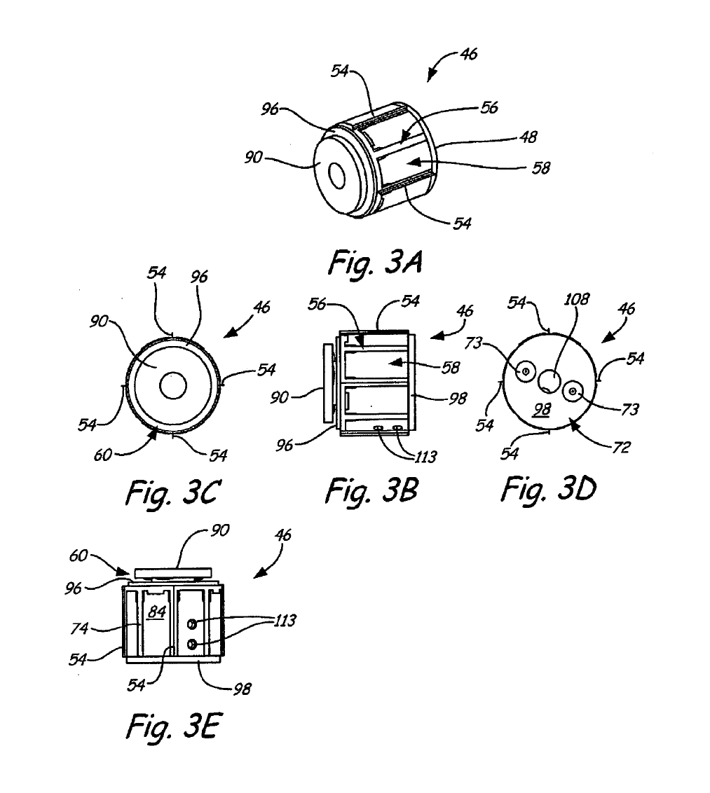

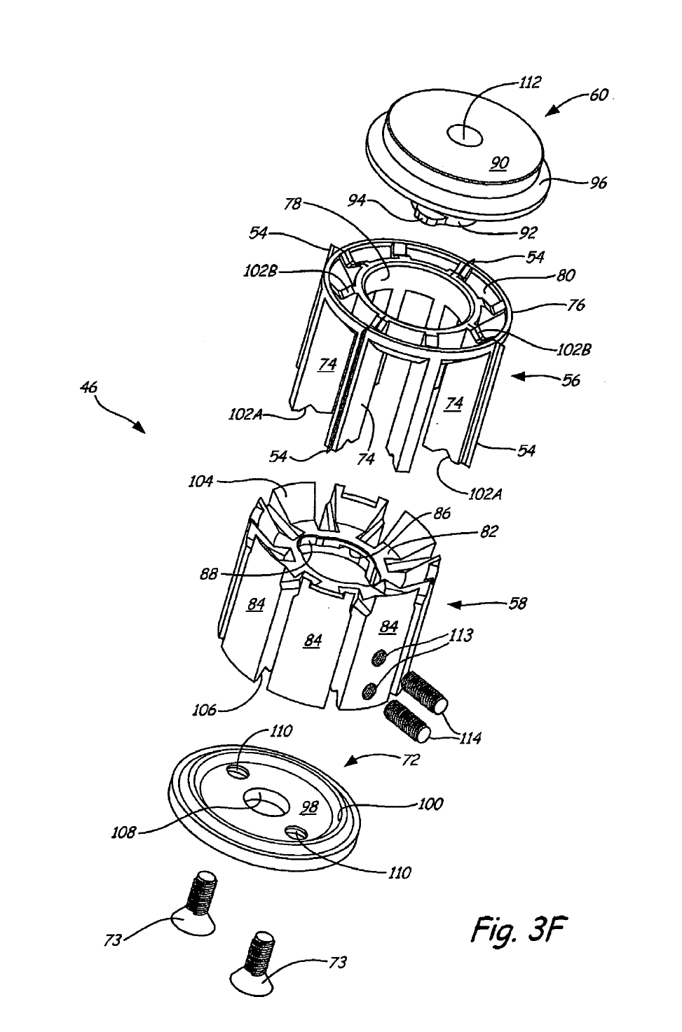

Air motor 22 rotates cutter blade head 46 by rotation of a drive shaft that extends substantially coaxially with shaft support 57 of air motor 22. Engagement of blades 54 with roller 62 causes anvil 48 to rotate as well. Anvil 48 drives rotation of idler wheel 50 through engagement with roller 68. Rovings fed into fiber inlet 38 are grabbed by anvil 48 and idler wheel 50 and pushed between anvil 48 and cutter blade head 46. Blades 54 of cutter blade head 46 are pushed into roller 62, which comprises a deformable material. The rovings are sliced between blades 54 and roller 62 as blades 54 rotate anvil 48 and cut into roller 62. Spacer spool 58 maintains blades 54 at even intervals so that the fibers are consistently cut into similarly sized lengths. Blades 54 and roller 62 become worn and eventually need to be replaced to prevent unacceptable performance degradation of fiber chopper 12. Roller 68 is slid off its mounting shaft and removed from housing 24 to perform maintenance. Retention cap 64 is removed to allow roller 62 to be replaced. Anvil 48 is slid off its mounting shaft to perform maintenance. Retention cap 60 is removed so that blade cartridge 56 can be replaced. Fasteners (shown in FIG. 3A) are removed from spacer spool 58 to allow cutter blade head 46 to slide off of the drive shaft of air motor 22.

FIG. 3A is a perspective view of cutter blade head 46 of FIG. 2C. FIG. 3B is a front view of cutter blade head 46 of FIG. 3A. FIG. 3C is a first side view cutter blade head 46 of FIG. 3B. FIG. 3D is a second side view of cutter blade head 46 of FIG. 3B. FIG. 3E is a front view of cutter blade head 46 of FIG. 3C. FIG. 3F is an exploded view of cutter blade head 46 of FIG. 2C showing blade cartridge 56, spacer spool 58, retention cap 60, end cap 72 and fasteners 73. Blade cartridge 56 comprises blade holders 74, outer ring 76, inner ring 78, end wall 80 and blades 54. Spacer spool 58 includes annular body 82, spacers 84, groove 86 and indent 88. Retention cap 60 includes end plate 90, central body 92, tab 94 and retention plate 96. End cap 72 includes retention plate 98 and ridge 100. FIGS. 3A-3F are discussed concurrently, with specific emphasis on FIG. 3C.

Blade cartridge 56 comprises a plurality of blade holders 74 that are connected together by rings 76 and 78. Blade holders 74 comprise elongate, rectangular bodies in which blades 54 are seated. In one embodiment, blade holders 74, outer ring 76, inner ring 78 and end wall 80 are formed from plastic with blades 54 being molded directly into cartridge 56. Not every blade holder 74 includes a blade. For example, in the embodiment shown, blade cartridge 56 includes eight blade holders 74 and only four blades 54, with blades 54 being located in every other blade holder 74. Blades 54 are typically of a high carbon steel construction and are about one-half to one inch in axial length (˜1.27 cm to ˜2.54 cm). Blade holders 74 are equally spaced around a circumferential perimeter defined by rings 76 and 78 so as to form radially extending, spoke-like structures surrounding a central bore extending through rings 76 and 78. Wall 80 extends between adjacent blade holders 74 to provide rigidity to blade cartridge 56. Blade cartridge 56 includes a plurality of end notches 102A and 102B that extend through blade holders 74 and blades 54.

Spacer spool 58 comprises annular body 82 through which a central bore extends. Annular body 82 also includes a flange extending into the central bore, the flange having groove 86 and indent 88. Spacers 84 extend radially from annular body 82 at equal intervals to form slots for receiving blade holders 74. Spacers 84 are V-shaped such that adjacent spacers 84 form rectangular slots to match the shape of blade holders 74. Spacer spool 58 comprises a solid body, typically molded from a plastic material, that provides support and rigidity to blade holders 74. In particular, spacers 84 prevent blade holders 74 from moving during engagement with roller 62 of anvil 48 (FIG. 2C) during a chopping process. Spacers 84 maintain blade holders in a generally axial direction with respect to a center axis of cutter blade head 46. In other embodiments, blade holders 74 may extend from rings 76 and 78 of blade cartridge 56 at an angle with respect to the center axis of cutter blade head 46 to enable diagonal cutting. As such, spacers 84 can extend at an angle along annular body 82 in various embodiments. Spacers 84 include surfaces 104 that engage flush with wall 80 of blade cartridge 56 when assembled with retention cap 60. Spacers 84 also include notches 106 that engage ridge 100 when assembled with end cap 72.

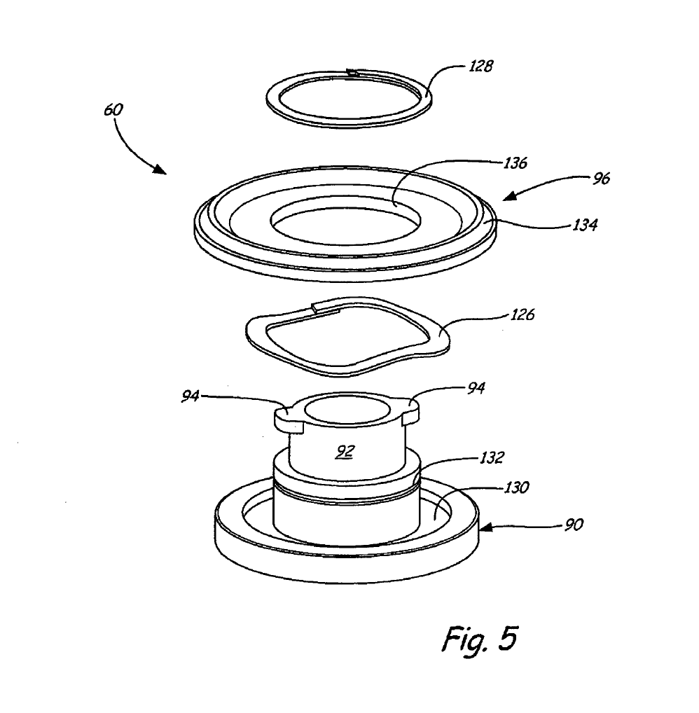

End cap 72 comprises retention plate 98 in the shape of a disk having a central bore 108 and fastener holes 110. Ridge 100 extends axially from plate 98 and has the inverse shape of notches 106 and 102A. Retention plate 98 is secured to spacer spool 58 by fasteners 73 that extend through holes 110 to engage threads in annular body 82. Retention cap 60, which is explained in greater detail with reference to FIG. 5, includes central bore 112. Retention plate 96 includes a ridge to engage notches 102B when central body 92 is inserted into spacer spool 58 such that tab 94 engages groove 86 in spacer spool 58.

Blade cartridge 56, spacer spool 58, retention cap 60, and end cap 72 include central bores that align along a central axis such that assembled cutter blade head 46 can be mounted to a drive shaft of air motor 22. Spacer spool 58 is provided with radially extending threaded bores 113 for receiving threaded set screws 114 to fasten cutter blade head 46 to the shaft of air motor 22. Retention cap 60 and end cap 72 are fastened to spacer spool 58 to maintain assembly with blade cartridge 56 and to provide a retention mechanism for blades 54. Threaded fasteners 73 are inserted into holes 110 in retention plate 98 and threaded into annular body 82. Ridge 100 of retention plate 98 engages notches 106 in spacer spool 58 and end notches 102A in blade cartridge 56. Similarly, retention plate 96 of retention cap 60 includes a ridge (shown in FIG. 5 as ridge 134) that engages end notches 102B in blade cartridge 56. The ridges engage blades 54 at end notches 102A and 102B to provide a mechanical barrier to radial displacement of blades 54, thus providing a retention means beyond the integral attachment of blades 54 with blade holders 74.

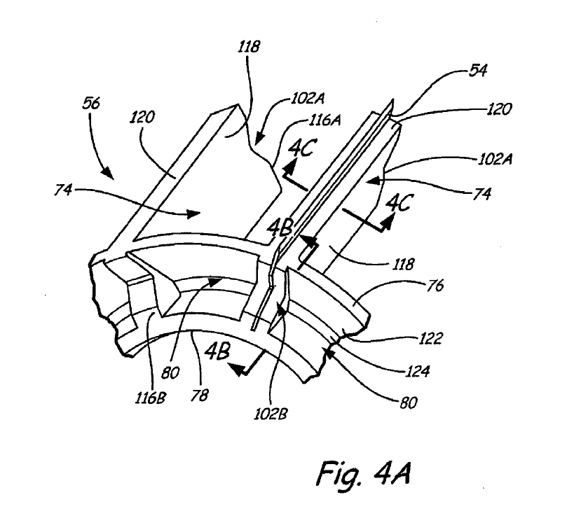

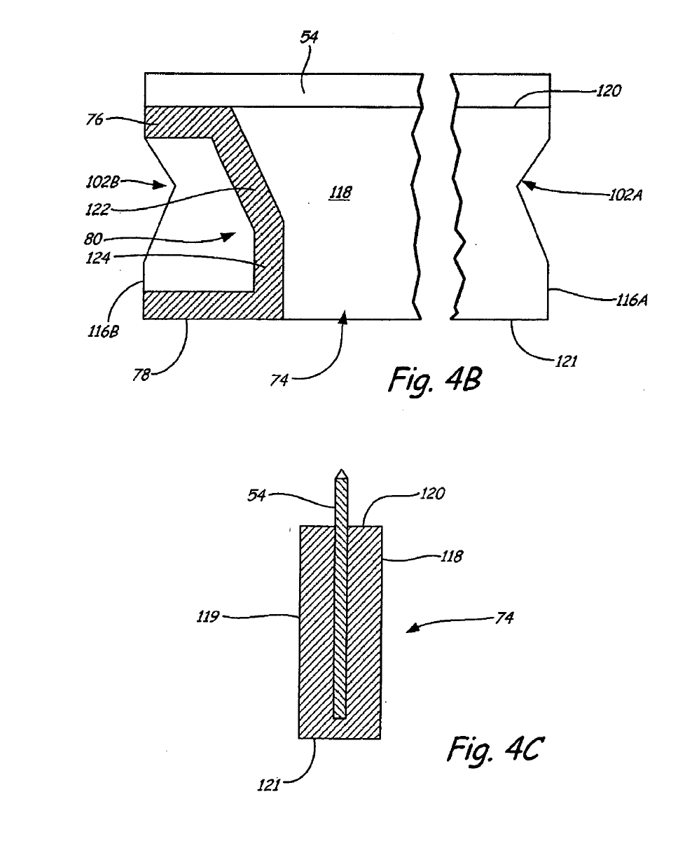

FIG. 4A is a partial perspective view of blade cartridge 56 of FIG. 3F showing segments of wall 80 connecting concentric outer and inner rings 76 and 78 that support a plurality of blade holders 74. FIG. 4B is a cross-sectional view of wall 80 of FIG. 4A taken at section 4B-4B. FIG. 4C is a cross-sectional view of blade holder 74 of FIG. 4A taken at section 4C-4C. FIGS. 4A-4C are discussed concurrently. Each blade holder 74 comprises a main body portion having first end 116A, second end 116B, first side wall 118, second side wall 119, radially outer wall 120 and radially inner wall 121. Wall 80 comprises a plurality of segments disposed between adjacent blade holders 74, each including outer portion 122 and inner portion 124.

Outer ring 76 and inner ring 78 extend between blade holders 74 to form part of wall 80 and join blade holders 74 in an annular array. Outer ring 76 extends between first side walls 118 and second side walls 119, and flush with outer walls 120 and first ends 116A. Inner ring 78 extends between first side walls 118 and second side walls 119, and flush with inner walls 121 and first ends 116A. Wall 80 includes a plurality of segments each bounded by outer ring 76, inner ring 78, a first side wall 118 and a second side wall. Each segment of wall 80 includes outer portion 122 and inner portion 124 that comprise planar surfaces joined at an angle to match the shape of surfaces 104 and annular body 82 of spacer spool 58 (FIG. 3F).

Blades 54 are integrally formed into blade holder 74 during manufacture of blade cartridge 56 such that blades 54 are immobilized within blade cartridge 56. As such, blades 54 are prevented from being radially displaced during rotation of cutter blade head 46. However, as can be seen in FIG. 4, blade holder 74 includes end notches 102A and 102B that extend through blades 54 to allow for an additional retention means. In particular, ridge 100 of retention plate 98 (FIG. 3) fits into end notch 102A and ridge 134 (FIG. 5) of retention plate 96 fits into end notch 102B to provide a positive, mechanical restraint to blades 54.

FIG. 5 is an exploded view of retention cap 60 of FIG. 3F showing end plate 90, central body 94, retention plate 96, biasing spring 126 and retaining ring 128. End plate 90 includes spring seat 130 and central body 92 includes ring seat 132. Retention plate 96 includes ridge 134 and bore 136.

Biasing spring 126 rests in spring seat 130 of end plate 90. Biasing spring 126 comprises a split wave spring ring that includes waves that protrude from spring seat 130 to engage retention plate 96. Bore 136 of retention plate 96 is fitted around central body 92 such that biasing spring 126 is retained between end plate 90 and retention plate 96. Retaining ring 128 comprises a split washer that snaps into ring seat 132. With retaining ring 128 seated in ring seat 132, retention plate 96 is prevented from sliding off of central body 94. Biasing spring 126 maintains retention plate 96 in engagement with retaining ring 128, but can be displaced toward end plate 90 when acted upon with force, such as when tabs 94 are engaged with annular body 82 of spacer spool 58 (FIG. 3)

With reference to FIG. 3F, to assemble cutter blade head 46, central body 92 is inserted into inner ring 78 of blade cartridge 56 and annular body 82 of spacer spool 58 with tabs 94 aligned with indents 88 (only one shown in FIG. 3F). In order to move tabs 94 past annular body 82, retention cap 60 must be pushed into blade cartridge 56 to compress biasing spring 126. Specifically, end plate 90 is pushed such that retention plate 96 is pushed against outer ring 76 and inner ring 78, thereby compressing spring 126. Once tabs 94 are past annular body 82, retention cap 60 is rotated ninety degrees so that tabs 94 align with grooves 86 (only one shown in FIG. 3F). Retention of tabs 94 in grooves 86 prevents rotation of central body 92 so that retention cap 60 does not become disengaged from spacer spool 58 without axial displacement followed by rotational displacement. With tabs 94 in grooves 86, spring 126 is still in a state of compression such that retention plate 96 is biased against outer ring 76 and inner ring 78, thereby maintaining ridge 134 in contact with notches 102B and ridge 100 in contact with notches 102A.

End notches 102A and 102B have V-shaped or triangular profiles in the embodiment shown. Ridge 100 includes an oppositely shaped profile to enable flush seating within end notch 102A. Ridge 134 (FIG. 5) of retention plate 96 includes an oppositely shaped profile to enable flush seating within end notch 102B. In other embodiments, end notches 102A and 102B can have other profiles instead of V-shaped or triangular, such as square, round or rectangular.

The present invention provides a system for maintaining razor blades in assembly with a cutter blade head that can be easily assembled and disassembled. For example, by simply pushing and twisting retention cap 60, cutter blade head 46 can be disassembled to access blade cartridge 58. Blade cartridge 58 provides an easy to manufacture and disposable component that allows multiple blades 54 to be swapped out of cutter blade head 46 in a single step. Furthermore, blade cartridge 58 integrally secures each blade 54 such that handling of individual blades is unnecessary, thereby increasing operator safety. Retention of blades 54 is further provided by engagement of ridges 100 and 134 of retention plate 98 and retention plate 96 with end notches 102A and 102B, respectively.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A blade cartridge for a fiber roving chopper, the blade cartridge comprising:
an annular support; and
a plurality of blades integrally seated in the annular support and extending radially outward from the annular support.

2. The blade cartridge of claim 1 wherein the annular support further comprises:
a plurality of blade holders extending from the annular support, each blade holder comprising:
a main body portion;
a first end of the main body portion connected to the annular support;
a second end of the main body portion opposite the first end such that the main body portion is cantilevered from the annular support;
a blade integrally seated in the main body portion and extending from the first end to the second end;
a first end notch located in the first end; and
a second end notch located in the second end.

3. The blade cartridge of claim 2 wherein the main body portion further comprises:
first and second side walls each extending from the first end to the second end, wherein the blade extends between the first and second side walls from the first end to the second end; and
a radially outer wall and a radially inner wall each extending between the first and second side walls, wherein the blade extends outward through the radially outer wall.

4. The blade cartridge of claim 3 wherein the first end notch and the second end notch extend through the main body portion and the blade from the first side wall to the second side wall.

5. The blade cartridge of claim 4 wherein the first end notch and the second end notch comprise V-shaped notches.

6. The blade cartridge of claim 3 wherein the annular support comprises:
a first ring connected to the radially inner wall adjacent the first end;
a second ring connected to the radially outer wall adjacent the first end; and
a wall portion comprising a plurality of segments connecting the first ring and the second ring between side walls of adjacent main body portions.

7. The blade cartridge of claim 3 and further including a spacer spool comprising:
an annular body fitted within the radially inner walls of the plurality of blade holders; and
a plurality of spacers extending radially from the annular body and fitted between the sidewalls of adjacent main body portions.

8. The blade cartridge of claim 7 and further comprising:
a retention cap coupled to the annular body of the spool, the retention cap including a first ridge seated in the first end notch; and
an end cap coupled to the annular body of the spool, the end cap including a second ridge seated in the second end notch.

9. The blade cartridge of claim 8 wherein:
the annular body of the spacer spool includes a central bore having a flange; and
the retention cap comprises:
an end plate;
a central body extending from the end plate and into the annular support and the central bore of the annular body;
a retention tab extending from the central body to engage the flange;
a retention plate positioned between the end plate and the annular support, the retention plate including the first ridge;
a spring positioned between the end plate and the retention plate; and
a retaining ring connected to the central body adjacent the retention plate.

10. A roving chopper comprising:
a chopper housing;
an anvil including a deformable roller body mounted for rotation on the chopper housing; and
a cutter blade head mounted for rotation to the chopper housing to engage the deformable roller body of the anvil, the cutter blade head comprising:
a blade cartridge comprising:
a plurality of blade holders cantilevered from a support; and
blades integrally formed into at least some of the holders;
a spacer spool having spacers inserted between the blade holders; and
a retention cap assembly for maintaining the blade cartridge assembled with the spacer spool.

11. The roving chopper of claim 10 and further comprising:
an air motor mounted to the chopper housing to provide rotational input to the anvil or cutter blade head; and
an idler wheel mounted for rotation on the chopper housing to engage the anvil.

12. The fiber roving chopper of claim 11 and further comprising:
inlet openings mounted to the chopper housing to feed rovings between the anvil and the idler wheel;
a cover mounted to the chopper housing; and
a dispenser mounted to the housing to receive chopped rovings from between the anvil and the cutter blade head and discharge the chopped rovings from the chopper housing.

13. The roving chopper of claim 10 wherein each of the plurality of blade holders comprises:
a main body portion;
a first end of the main body portion connected to the support;
a second end of the main body portion opposite the first end such that the main body portion is cantilevered from the support;
a blade seated in the main body portion and extending between the first end and the second end;
first and second side walls extending between the first and second ends alongside the blade;
a first end notch located in the first end and extending through the first and second side walls and the blade; and
a second end notch located in the second end and extending through the first and second side walls and the blade.

14. The roving chopper of claim 13 wherein the support comprises:
a first ring connected to the inner wall adjacent the first end;
a second ring connected to the outer wall adjacent the first end; and
a wall portion comprising a plurality of segments connecting the first ring and the second ring between sidewalls of adjacent main body portions.

15. The roving chopper of claim 13 wherein the spacer spool further comprises:
an annular body fitted inside the side walls of the plurality of blade holders; and
the spacers extend radially from the annular body to fit between the sidewalls of adjacent main body portions.

16. The roving chopper of claim 13 wherein the retention cap assembly further comprises:
a first retention plate having a first ridge extending into the first end notch; and
a second retention plate having a second ridge extending into the second end notch.

17. The roving chopper of claim 16 wherein the retention cap assembly further comprises:
an end plate;
a central body extending from the end plate and into the first retention plate, the blade cartridge and the spacer spool;
a retention tab extending from the central body to engage the spacer spool;
a spring positioned between the end plate and the first retention plate; and
a retaining ring connected to the central body adjacent the first retention plate.

18. A chopper blade head for a roving chopper device, the chopper blade head comprising:
a blade cartridge comprising:
a support ring having a central axis extending through a circumference;
a plurality of blade holders extending axially from the support ring and being spaced circumferentially around the support ring circumference;
a plurality of blades extending radially from at least some of the blade supports;
a spacer spool comprising:
an annular body fitted inside the plurality of blade holders; and
a plurality of spacers extending radially from the annular body to form circumferentially spaced slots for receiving the plurality of blade holders; and
a retention cap assembly comprising first and second retention plates assembled to the spacer spool to maintain the blades secured to the blade cartridge.

19. The chopper blade head of claim 18 wherein the blade holders of the blade cartridge comprise:
a main body portion having first and second side walls extending from a first end to a second end of the main body portion such that the blades extend between the first and second side walls;
a first end notch located in the first end and extending through the first and second side walls and the blade; and
a second end notch located in the second end and extending through the first and second side walls and the blade,
wherein the first retention plate comprises a first ridge to engage the first end notch and the second retention plate comprises a second ridge to engage the second end notch.

20. The chopper blade head of claim 19 wherein the retention cap assembly further comprises:
an end cap having a biasing spring to maintain the first retention plate engaged with the first end notch; and
threaded fasteners secured to the spacer spool to maintain the second retention plate engaged with the second end notch.
